(19) United States
(12) Patent Application Publication
(10) Pub. No.: US 2020/0074501 A1
(43) Pub. Date: Mar. 5, 2020

(54) Location Measurement and Analytic System for Out of Home Advertisements

(71) Applicants: Ian Gerard, Lyndon, KY (US); Brandon Bush, Lyndon, KY (US)

(72) Inventors: Ian Gerard, Lyndon, KY (US); Brandon Bush, Lyndon, KY (US)

(21) Appl. No.: 16/555,587

(22) Filed: Aug. 29, 2019

Related U.S. Application Data
(60) Provisional application No. 62/725,585, filed on Aug. 31, 2018.

(51) Int. Cl. G06Q 30/02; H04W 4/021; G09F 21/04

(52) U.S. Cl. CPC G06Q 30/0246; G09F 21/04; H04W 4/021

(57) ABSTRACT

A system for determining the effectiveness of out of home advertisements using cell phone location data from mobile phone aps. The system determines the location of the advertisement, either stationary or mobile, develops a possible user viewing radius, then requests phone location data from third party aggregators. It then evaluates the phone users located near the advertisement to determine who may have viewed the ad, to create a count of ad impressions.

### FIELD OF THE INVENTION

This invention relates to system for determining and analyzing data regarding the views or impressions of outdoor advertisements.

### BACKGROUND OF THE INVENTION

There are a number of different “out of home” advertisement mediums. Many are static or stationary advertisements like the sign at a business or a billboard at the side of the road. There are also a number of mobile advertisement platforms, like ads posted on the side of a bus or a truck. There are even small sign trucks that are essentially a billboard sized sign mounted on the back of a truck. Many businesses put advertisement signs on the sides of their company owned vehicles. Modern painting and plastic technologies have created a vehicle wrap advertisement that is a large sign that adheres to parts of a vehicle or even the entire vehicle. A number of companies, including the present applicant, have developed businesses around arranging for companies to place advertisements on vehicles owned by individuals or third parties.

The purpose of these out of home advertisements (and of all advertisement) is to raise awareness of the product or the company with the public at large, but also to be seen by the relevant purchasing public for the product or service that is advertised. Simply put, the primarily goal of any advertisement is to be viewed by as many people as possible. It is obviously better to have a billboard on a heavily trafficked city street than a sparsely traveled country road. One measure of the effectiveness of an advertisement (or ad) is the number of people who see it, and the times it is seen. Each time a person views the advertisement is called an “impression.” The value of the ad is measured by the number of impressions. The more impressions, the more valuable the ad, and the more valuable the ad, the more a company will pay the advertiser for the ad. It is important, therefor, to accurately determine the number of impressions for any advertisement.

It is relatively easy to develop a very rough estimate of the number of impressions for a roadside billboard. Most communities collect traffic data, so the number of cars traveling down the road where the ad is placed can be determined, the occupancy of the vehicles can also be estimated, and so a very rough estimate of the number of impressions can be determined. But rough estimates are little more than guesses, and often give an advertiser very little information about how effective their advertisements are.

One of the issues encountered with the growing field of mobile, vehicle-based advertising, is accurately pricing the ads. This is because it can be extremely difficult to determine the impressions for those ads because the ad itself is mobile, moving in traffic.

There are a number of new and emerging technologies that create the opportunity to more accurately determine the number of impressions, and hence the value, of an advertisement, and particularly of mobile advertisements. Most people now carry smart phones, and most people use aps—or phone-based computer application programs—that require phone location data. An example is a map ap like Google Maps. The phone user can use Google Maps to determine the user's location, and to provide directions to another location. This obviously requires that the phone location data is provided to Google Maps. There are a number of other phone aps that also require the phone location data. This includes, but in no way is limited to driving aps like WAZE, transportation or ride hailing aps like LYFT and UBER, weather aps that provide local weather forecasts and weather radar, review aps like Yelp. Each of these aps allows the phone user to locate themselves within a town or city so that they can arrange for a ride (UBER and LYFT) or find a restaurant (Yelp, Trip Adviser, etc.) Many social media platforms, like Facebook, Twitter, Snapchat, Instagram and others collect location data of their users. Because of the user agreement of these aps and social media platforms, this location data is not private. And many of these companies aggregate and sell this location data.

There are other companies, such as INRIX, that aggregate that location data in real time. This allows a subscriber to a service like INRIX to gain information about how many people are at a given location. Based on this data, and comparisons with other public data like traffic volume reports, is it possible to determine more accurately the number of impressions for an outdoor advertisement. It is also possible to correlate this data with other available data, such as Google searches or purchases through websites or smart phone apps, to determine the effectiveness of an advertisements. This data can be used to determine the number of impressions of an ad and the effectiveness of the ad, and this can be to determine the cost for that advertisement. This data can also be used by a mobile advertisement provider to direct their vehicle-based ads to the best areas for advertising. This data can also be used to compensate the drivers of the mobile advertisements.

### SUMMARY OF THE INVENTION

The present invention uses and analyzes real time location data from individuals' smart phones to determine the number of impressions for an advertisement. It also uses this data to allow a vehicle-based advertisement to change its location to maximize the number of impressions. The invention uses GPS (Global Positioning System) data from the vehicles carrying the mobile advertisement. It also uses third party data on traffic and phone usage and location data to determine the best places for the ads to travel, and the number of impressions for each ad. This maximizes the value of the ad for the company purchasing the ad. It also maximizes the revenue for the company that owns or arranges for the vehicles to carry the ads.

The use of smart phone and a variety of phone-based aps with location data allows more accurate information regarding the individuals who are in proximity to the specific advertisement. A variety of demographic information is collected regarding smart phones and phone aps with location data. This includes information from social media users. This information can include age, gender, ethnicity, relative income, social status, and purchasing habits. This data can be used to determine the likelihood that an individual may be interested in a specific product advertised on a specific platform. This data can be used to make accurate predictions about the value of an advertisement, and can also be used to direct a mobile advertisement platform to a certain location.

Many people also use their smart phones to conduct research into products, visit websites, and make purchases. This information is tracked and stored by the search engine used. It is possible, therefore, for a company with a message on a billboard to determine if an individual who has been in proximity to the advertisement then visits the company's web site, or does an internet search (through Google® or other internet search engines), or makes a purchase of the advertised product through the company website or through a third party website like Amazon.com®. This data can be used to determine the effectiveness of the advertisement, and this data can be used to price the advertisement, as well as be used by the company to modify or improve its advertisements.

### DESCRIPTION OF THE DRAWINGS

FIG. 1 is a flowchart with an overview of the Advertisement Impression Measurement System.

FIG. 2 is a detail of a vehicle impression calculation system for a mobile advertising platform.

FIG. 3 is a detail of the impression calculation system for foot traffic.

FIG. 4 is a graphic describing the dwell time measurement system.

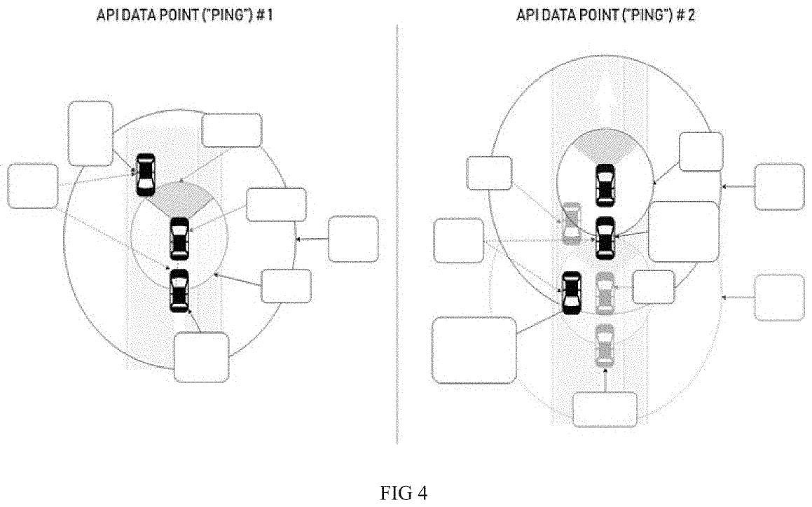

### DETAILED DESCRIPTION OF THE INVENTION

Detailed embodiments of the present invention are disclosed herein. It is to be understood that the disclosed embodiments are merely exemplary of the invention and that there may be a variety of other alternate embodiments. The figures are not necessarily to scale, and some features may be exaggerated or minimized to show details of particular components. Therefore, specified structural and functional details disclosed herein are not to be interpreted as limiting, but merely as a basis for teaching one skilled in the art to employ the varying embodiments of the present invention.

The invention measures the effectiveness of out of home advertising, which can be static like a standard billboard or the sign on a building, or mobile like a sign on a car or truck, or a car “wrap” which is a plastic applique that covers an entire automobile. The invention takes information from [third party aggregators] that acquire and accumulate location information from mobile phone applications (or aps) and then determines how many phone users are in proximity to the out of home advertisement to potentially view the ad. Each potential viewer of a ad is called an “impression,” and the value of an ad is evaluated by its impressions.

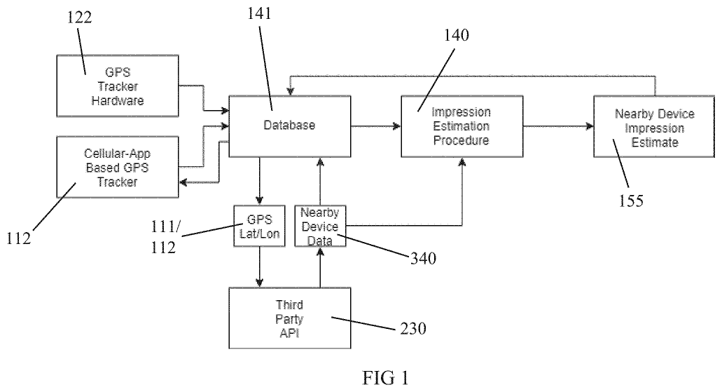

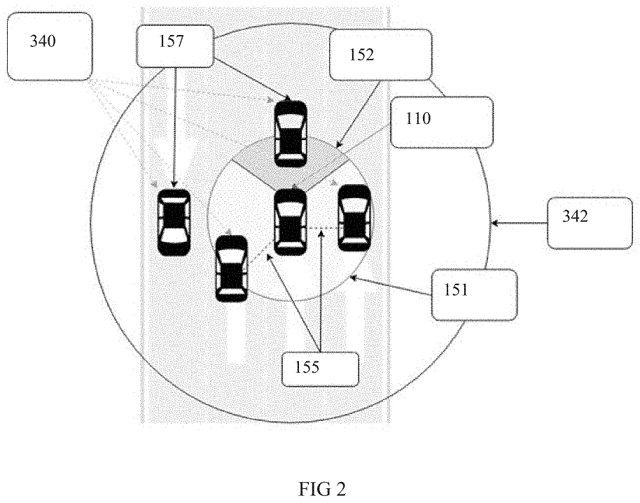

FIG. 1 is a basic flow chart of the invention, and FIG. 2 is a graphic representation of a mobile ad 110 located on a vehicle, and number of potential impressions 210, which are vehicles in relatively close proximity to the mobile ad 110. The main components of the advertisement impression measurement system 100 are the advertisements, which are either mobile ads 110 or static ads 120. Mobile ads 110 are advertisements located on a vehicle. In the most common form the mobile ad 110 is a “vehicle wrap” or large graphic that is placed over the car, and that includes an ad, thus turning the vehicle, typically a car, into an advertisement. The system also incorporates static ads 120, like billboards and building signs and the like, because, in many cases, a company will advertise on both mobile and static platforms, and it is possible, with the present invention, to coordinate these two forms of advertising.

The location of the static ads 120 are known. Their location data is supplied to the system by means of standard GPS tracker hardware 122. The location of the mobile ads 110 are constantly changing because they are carried on vehicles. The mobile ad location data 111 is provided in one of two ways, either by a GPS tracker 122, or by a location generating phone ap 112 on a cellular smart phone carried in the vehicle. Most smart phones include an integrated location program that determines the location of the phone by obtaining location information from nearby cellular phone signal towers, as well as nearby wi-fi networks, and in some cases satellite GPS systems. This location data is necessary for the phone operation because it needs to get a signal for a nearby cell phone tower. Many smart phone aps, or computer applications that run on a smart phone, include location data from the phone that is integral to the operation of the ap. One of the most common, and easiest to explain, is Google Maps, which provides a street map, and shows the current location of the phone on the map. The user can use Google Maps to help navigate around town. The user can enter a desired destination, and Google Maps will provide directions to travel from the present location to the desired destination, with a turn by turn guide. Obviously this requires precise location data from the phone. There are many other phone aps that require precise location of the phone. This includes a number of weather aps, but also ride sharing aps like UBER® and LYFT®, travel and review aps like Trip Adviser® and Yelp®, and dating aps like Tinder®. Many social media platforms, like Twitter, Facebook, Snapchat, and Instagram, also can use location data. Many of these companies sell parts of the phone location data. In most cases these companies only sell the location data. But this is instantaneous data, so it can show that there are a certain number of cell phones on a certain street at any time of the day. According to some sources nearly 96% of the adults in the United States own a cell phone. So tis aggregate phone user location data can present a fairly accurate accounting of where people are located at any given time. The mobile ad location data 111 can be provided by obtaining this information from the phone, or from a third-party aggregator of phone usage data.

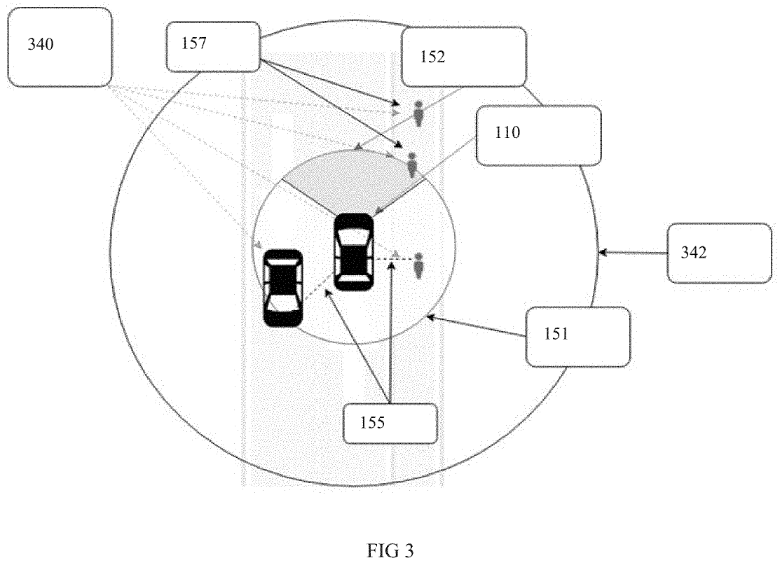

The location measurement system of the present invention purchases this publicly available data from one of the third-party aggregators, such as INRIX. These third-party aggregators, Third-Party API 230 sell phone user location data 340 based on location. So the Impression Analysis Program 140 takes the location data of the ad, either 111 or 121, and develops a proximity radius 342, which is close to the ad, and inputs that proximity radius 342 location data into the Third-Party API 230, which responds by returning information on nearby phone user location data 340, or those phones within the proximity radius 342. The Third-Party API 230 will return data based on user set criteria, so for example, the user can request phone user location data 340 within 50 feet of the requested location. But this phone user location data 340 only tells who is in relative proximity to the ad 110 and 120, and this is not the same thing as actually being in position to view the ad, and therefore is not a counted impression 155 of the ad. FIG. 2 graphically shows this, starting with the location of the mobile ad 111, and the proximity of the third party phone user locations 340 within the proximity radius 342. The phone user location data 340 is then analyzed by impression estimate procedure 140 to determine what is an actual counted impression 155. Because the vehicle carrying the mobile ad 110 is moving, potential viewers in front of the ad 110 are not counted. This wedge of area in front of the ad 110 is the impression exclusion zone. And potential viewers outside of a predetermined visible Impression Radius 150, which is inside the proximity radius 342, are also not counted. The remaining vehicles, based on phone user location data 340 are counted as actual counted impressions 155. FIG. 3 shows a similar situation but includes people out of their cars walking along the street. The Third-Party API 230 provides cell phone location data 340 and does not necessarily focus on cell phone users in a car. However, since the Third-Party API 230 provides instantaneous, real time data it will be obvious which cell phone user is in a moving vehicle, and who is not.

The invention is described below through the steps of the process of acquiring information for evaluation. The components related to that process are described at each step. Many, but not all of these steps involve the use of a computer algorithm, which is described after the step.

STEP 1. The first step is to determine the location of an out of home advertisement for the purpose of measuring impressions, unique impressions, conversions, and other data pertinent to out of home advertisements, as established in the following steps. The system uses either a mobile application or other type of GPS tracking system that can transmit GPS coordinates to an internet server to establish the location 111 of the mobile advertisement 110. The system uses a series of GPS coordinate points for stationary or static advertisements 120.

During normal operation, the system uses algorithms to assess the validity of a given location update in Step 1. If the algorithm determines the location is a valid and accurate representation of the user's location, it prepares and transmits the location data via the system in step 2 to a database on a server. If the algorithm determines the location is invalid, or an inaccurate representation of the user's location, it removes the current location data from memory, and continues normal operation. The system utilizes the internal hardware of the GPS device to obtain location data, in the form of latitude and longitude coordinate pairs, at the given time. Once this location data is obtained, it is prepared for transmission. The mobile application or GPS tracking system first checks for internet connectivity. If the device is not connected to the internet, the data is cached to local storage for later transmission/retrieval. If the device is connected to the internet, it is sent via the Application Programming Interface (API) to a server, which processes it as described in step 2. The device then checks the local storage to see if there are any cached data points that need to be retransmitted. If so, it re-transmits them now.

STEP 2. A system that transmits the ad location GPS coordinates to a database on a server that then catalogues and stores the ad location GPS coordinates, route data, and other data pertinent to the out of home advertisement, vehicle route, or static location being analyzed. The system, upon receiving ad location data to transmit to a database on a server, queries the internal hardware to determine internet connectivity. If the system is not connected to the internet, the ad location data is cached to local storage for later transmission/retrieval. If the system is connected to the internet, the ad location data is sent via an API to a database on server. The system waits for a response from the server. If the response indicates the transmission was unsuccessful, the system stores the ad location data to local storage for later transmission/retrieval. If the response indicates the transmission was successful, the system queries the local storage, retrieving any relevant stored location data points from previous operation. If there are no stored data points, the system resets and continues normal operation. If there are stored data points, the system transmits the first stored data point to a database on a server and waits for a response. If the response indicates the transmission is successful, the system resumes normal operation. If the response indicates the transmission was unsuccessful, the system stores the ad location data to local storage for later transmission/retrieval, and resets.

The system determines which information is to be analyzed, retrieves it from the database, and prepares it for transmission. The system then transmits the data to the third-party API, and waits for a response. If the response indicates the transmission was successful, the system parses the response, utilizing the system described in step 2 to store the information into the database. If the response indicates the transmission was unsuccessful, the system can do one of two things: (1) If the failure was due to connectivity issues, either on the Adder side or third-party API side, the data is flagged in the database for re-transmission at a later time, or (2) If the failure was due to malformed data (improperly prepared), the data is flagged for re-transmission and the system administrator is notified of the error.

STEP 3. A method using machine code from the system in step 2 that sends the GPS coordinate data to third-party data distributors via API, or Application Programming Interface. The third-party company then analyzes the GPS coordinate data, and returns relevant data to the system in step 2, such as nearby device identifiers and their locations, to determine who is near our out of home advertisement. The system determines which information is to be analyzed, retrieves it from the database, and prepares it for transmission. The system then transmits the data to the third-party API, and waits for a response. If the response indicates the transmission was successful, the system parses the response, utilizing the system in step 2 to store the information into the database. If the response indicates the transmission was unsuccessful, the system can do one of two things: (1) If the failure was due to connectivity issues, either on the Adder side or third-party API side, the data is flagged in the database for re-transmission at a later time, (2) If the failure was due to malformed data (improperly prepared), the data is flagged for re-transmission and the system administrator is notified of the error.

STEP 4. A method that returns nearby device identifier information, route data, time signatures, weather conditions, and other pertinent information returned from internal data or data returned via the third-party API in step 3, which are returned to the system in step 2. The returned third-party data is then cataloged with the GPS coordinate data from step 1 in the system from step 2.

STEP 5. A method that generates estimates of visual impressions for the out of home advertisement located at the coordinates identified in step 1 using the system in step 4 to identify nearby devices, which is then filtered through a series of algorithms to determine a more accurate estimate of visual impressions.

STEP 6. A method that generates estimates of foot traffic for a stationary location or set geofence region at the coordinates identified in step 1 using the system in step 4 to identify nearby devices, which is then filtered through a series of algorithms to determine a more accurate estimate of foot traffic in a particular location.

For both Step 5 and Step 6, the system iterates through each set of third-party data returned by step 4. For each third-party data point, the system determines a relative position of the returned device to the original out of home advertisement, stationary location, or set geofence. If the device is located within the “visible impression radius,” the device is counted as a visual impression, and is catalogued and stored in a database in a server using the system in following Steps 7 and 8. If the device is not located within the “visible impression radius,” the third-party data is discarded, and the system is reset.

STEP 7. A machine code system stored on the system in step 2 that stores the visual impression estimates generated by the system in step 5.

STEP 8. A machine code system stored on the system in step 2 that stores the foot traffic estimates generated by the system in step 6.

STEP 9. A method that compares device identifier information, route data, time signatures, weather conditions, and other information stored with the visual impression estimates from Steps 5 7 with device identifier information, route data, time signatures, visibility/weather conditions, and other information stored with the foot traffic estimates from Steps 6 and 8 to determine if a consumer in range of a GPS coordinate associated with a mobile or stationary out of home advertisement has then travelled to a particular location associated with the out of home advertisement. The system compares the data from Steps 5 and 7 with stored data retrieved via Step 4 to a set geofence location, based around a location set by the advertising client. If the comparison indicates that a consumer has entered the set geofenced location, an algorithm determines the amount of time spent within that geofence. If the consumer was located within the geofenced location for a specified period of time, the data is counted as a “conversion” and stored using the system in Step 4. If the consumer was located within the geofenced location, but for a lesser period of time than the specified period, the data is discarded.

STEP 10. A system that uses machine code to filter device identifier information, route data, time signatures, visibility/weather conditions, and other information pertinent to out of home advertisements based on relative position to the visible area around an advertisement using static or variable geofences depending on route data, time signatures, weather conditions, and other factors contributing to visibility of the out of home advertisement. The system compares the data retrieved via Steps 5 through 8 to adjust the visual range of an advertisement utilized in Steps 5 and 6.

STEP 11. A method that estimates route, directionality, and speed of nearby devices returned by the system in Step 4 using internal data or a third-party API to generate low to medium confidence estimates.

STEP 12. A method that estimates time exposed to a vehicle based or other out home advertisement by identifying nearby devices returned by the systems in Step 4 and Step 11 using internal data or data returned by a third-party API. The system uses data retrieved from Steps 3, 4, and 11, as well as internal data, to compare locations of previously identified third-party devices within a radius of a vehicle based or out of home advertisement. The system checks every ping for a list of devices. The system then iterates through each individual device, determining if the device was within visual range of an advertisement within a previous amount of pings. If the system determines that a device has been present in more than one ping within a specified time range, the system tallies the total amount of time the device was exposed to the advertisements visual range, and stores that using the system in Step 2.

STEP 13. A method that calculates the best route for a mobile advertisement to drive a particular location using internal data or data from a third-party API combined with a machine code algorithm that calculates the best route for the greatest number of estimated impressions. The system uses data retrieved via third-party APIs, and compares the returned route information using internal data. The system presents a list of possible routes from an origin point to the desired destination to the user of the mobile application, along with a display of information informing them of the estimated impressions of each route and allowing them to make a decision on which route to take. Once a route has been selected, the system acts as a navigation system, using location updates of a mobile device to properly route the user to the specified destination.

STEP 14. A method that calculates the overall potential reach of an out of home advertisement or vehicle based graphic advertisement based on number of mobile ads, miles driven, and other factors using population density information and other internal data or third party data pertinent to the out of home advertisement or vehicle based graphic advertisement. The system combines information from Steps 3 to 12, storing it in a database on a server using the system described in Step 2.

STEP 15. A system for reviewing measurements of maps, routes driven, impressions, foot traffic, vehicle traffic density, visibility/weather conditions, and other pertinent data in a graphic layout to visually represent geospatial data across a map.

STEP 16: A system for reviewing measurements of maps, routes driven, impressions, foot traffic, vehicle traffic density, and other pertinent data in a table or other data layout to numerically represent geospatial data across a map.

STEP 17. A system using barcodes and other encoded, scannable media on vehicle based graphic advertisements and other out of home advertisements for the purpose of marketing, data collection, and other information dissemination and transmission. When used, these scannable media will report any interaction back to the system

STEP 17. The system accepts information in the form of an HTTP request. This HTTP request is made when a mobile application or other barcode or encoded media scanner scans a barcode or other encoded media. The system accepts the HTTP request, along with additional data sent with the request, stores this information in a database on a server using the system in step 2, retrieves the final destination website as encoded in the barcode or other encoded media, and returns this website to the calling mobile application.

STEP 18. A system for designing, arranging, uploading, or otherwise creating graphic assets [what is a graphic asset??] to be used on GPS tracked out of home advertisements and vehicle based graphic advertisements. The system allows a user to upload a graphical asset in a specified format. When the asset has been uploaded, an editor allows the user to make basic graphical changes to the asset. For every individual change that occurs, the system determines if it is a valid change based on several criterion. If it is not a valid change, the system resets to the previous state and resumes normal operation. If it is a valid change, the system accepts the change, and resumes normal operation. Upon completing modifications to the asset, the system accepts and stores the data in a database on a server for later use.

STEP 19. A system for targeting and estimating specific consumer populations based on active or recent locations, demographics, behaviors, and other characteristics using internal data and third-party API data combined with GPS coordinate and location data. The system queries third-party APIs to determine geographical locations of devices and other relevant points within a radius centered on a specific geographical coordinate that match a specified set of criterion. For each location that matches the criterion, a data point is constructed and stored in a database on a server for later retrieval.

The present invention is well adapted to carry out the objectives and attain both the ends and the advantages mentioned, as well as other benefits inherent therein. While the present invention has been depicted, described, and is defined by reference to particular embodiments of the invention, such reference does not imply a limitation to the invention, and no such limitation is to be inferred. The depicted and described embodiments of the invention are exemplary only and are not exhaustive of the scope of the invention. Consequently, the present invention is intended to be limited only by the spirit and scope of the claims, giving full cognizance to equivalents in all respects.

We claim:

1. A method for evaluating the effectiveness of out of door advertising comprising the steps of:
determining the location of an out of door advertisement;
establishing a proximity radius around the location of said out of door advertisement;
requesting and collect cell phone location data on cell phones within said proximity radius from a third-party location aggregator;
establish an impression zone radius around the location of said out of door advertisement and an impression exclusion zone within said impression zone radius in front of said out of door advertisement to establish an impression zone;
analyze collected cell phone location data to determine the number of cell phones within said impression zone, to determine the potential viewers of said out of door advertisement.
